(19) United States
(12) Patent Application Publication
(10) Pub. No.: US 2023/0328587 A1
(43) Pub. Date: Oct. 12, 2023

(54) MULTI-TECHNOLOGY MULTI-USER IMPLEMENTATION FOR LOWER MAC PROTOCOL PROCESSING

(71) Applicant: EdgeQ, Inc., Santa Clara, CA (US)

(72) Inventors: Vishwanatha Tarikere Basavaraja, Karnataka (IN); Vivek Goyal, Indore Madhya Pradesh (IN)

(73) Assignee: EdgeQ, Inc, Santa Clara, CA (US)

(21) Appl. No.: 17/717,027

(22) Filed: Apr. 8, 2022

(51) Int. Cl. H04W 28/06; H04L 69/22

(52) U.S. Cl. CPC H04W 28/06; H04L 69/22; H04W 80/02

(57) ABSTRACT

With advanced compute capabilities and growing convergence of various wireless standards, it is desired to run multiple wireless standards on a single hardware together. Embodiments are disclosed for lower MAC protocol processing across multiple wireless standards and multiple radios. A common hardware may be used for processing lower MAC flows across multiple wireless standards, e.g., Wi-Fi, LTE, or 5G NR, multiple radios within a wireless standard, multiple users within a wireless standard, and/or different directions of radio. The implementation may support partial data processing of a flow, switching across flows, and context saving/restoring of flows. Furthermore, for better performance, looking ahead of flows and prefetching of context and data may also be implemented. Embodiments of the present patent disclosure may result in a very area-efficient and power-efficient hardware implementation for lower MAC protocol processing.

### TECHNICAL FIELD

The present disclosure relates generally to systems and methods for data packet processing. More particularly, the present disclosure relates to systems and methods for lower MAC protocol processing across multiple wireless standards and multiple radios.

### BACKGROUND

With advanced compute capabilities and growing convergence of various wireless standards, it is desired to run multiple wireless standards, e.g., 4G, 5G, or Wi-Fi, on a single hardware together. Typical solutions include developing dedicated hardware accelerators for each wireless standard, for each radio per wireless standard, and even dedicated hardware for each direction (receiving/transmitting, also known as RX/TX). Such solutions may have disadvantages of high area, high power, and complex implementation due to excessive hardware interfaces.

Accordingly, what is needed are systems, devices and methods for data packet processing across multiple wireless standards and multiple radios to improve hardware resources utilization and efficiency in power consumption.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

Figure (“FIG.”) 1A depicts layer architecture of an Open Systems Interconnection model (OSI model) with multiple layers.

FIG. 1B depicts a layer architecture of a 5G new radio (NR) protocol structure.

FIG. 2A depicts a structure of a wireless local area network (WLAN) MAC data frame.

FIG. 2B depicts typical frame structure of a long-term evolution (LTE) MAC protocol data unit (PDU).

FIG. 2C depicts a typical frame structure of a 5G NR MAC PDU.

FIG. 3 graphically depicts a schematic of lower MAC protocol processing for receiving data flows across multiple wireless standards, according to embodiments of the present disclosure.

FIG. 4 graphically depicts a schematic of lower MAC protocol processing for transmitting data flows across multiple wireless standards, according to embodiments of the present disclosure.

FIG. 5 depicts a process of lower MAC protocol processing across multiple wireless standards, according to embodiments of the present disclosure.

FIG. 6 depicts a process of switching data flow processing, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms and any examples are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” or “packet” shall not be interpreted as limiting embodiments of the present invention to 5G networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

A. OSI Model and MAC Layer

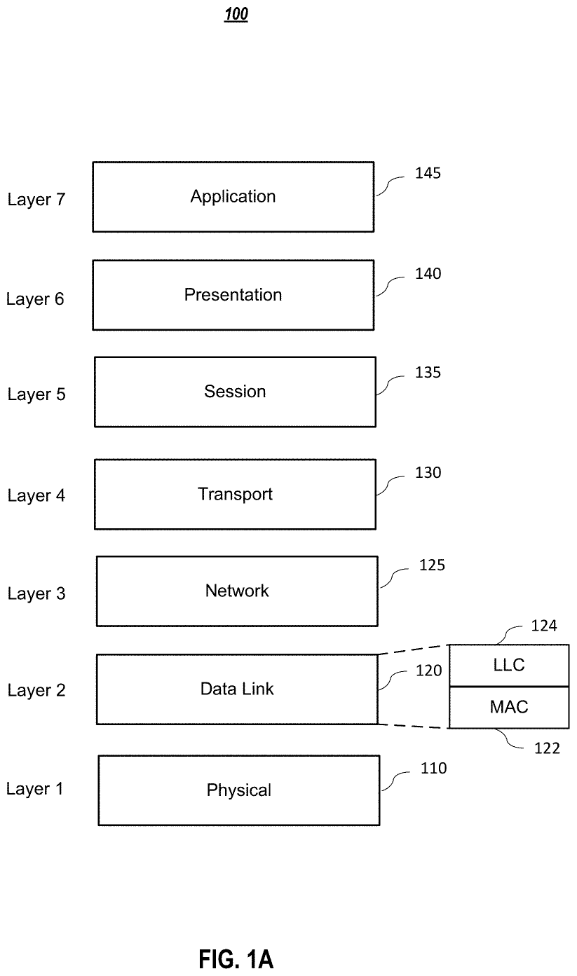

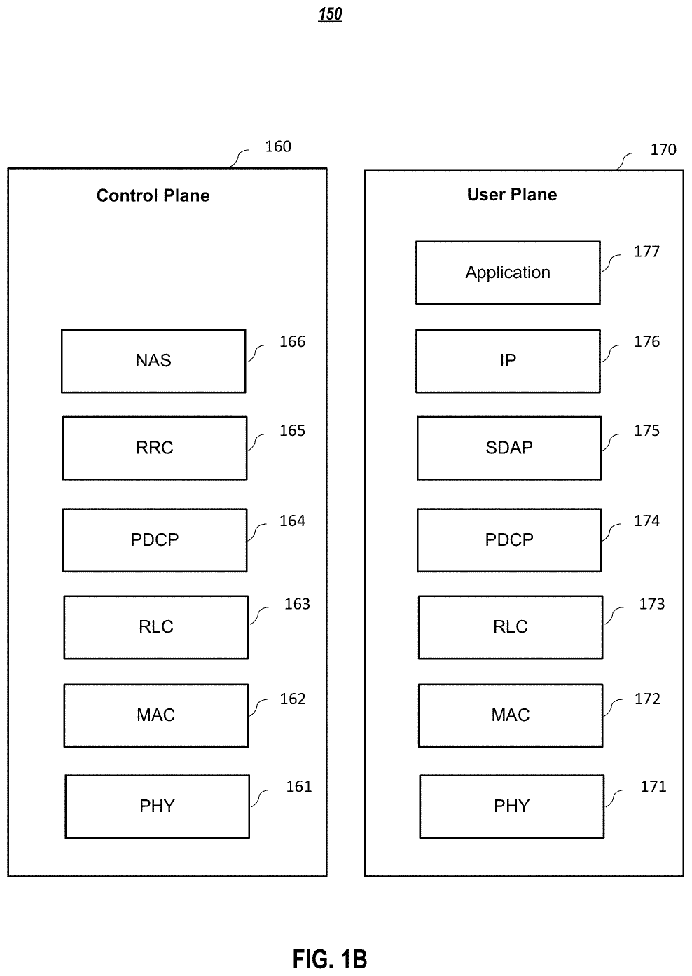

FIG. 1A depicts a layer architecture of an OSI model, which characterizes and standardizes communication functions of a telecommunication or computing system. OSI model provides the interoperability of diverse communication systems with standard communication protocols. The OSI model comprises seven layers, including layer 1 as a physical layer 110, layer 2 as a data link layer 120, layer 3 as a network layer 125, layer 4 as a transport layer 130, layer 5 as a session layer 135, layer 6 as a presentation layer 140, and layer 7 as an application layer 145. The physical layer 110 is responsible for transmission and reception of unstructured raw data between a device and a physical transmission medium. It converts the digital bits into electrical, radio, or optical signals. The data link layer 120 provides a link between two directly connected nodes and detects and possibly corrects errors that may occur in the physical layer. The data link layer 120 defines the protocol to establish and terminate a connection between two physically connected devices and also the protocol for flow control between them. The data link layer into two sublayers, a medium access control (MAC) sublayer 122 and a logical link control (LLC) sublayer 124. The MAC layer 122 is responsible for controlling how devices in a network gain access to a medium and permission to transmit data. The LLC sublayer 124 is responsible for identifying and encapsulating network layer protocols, and controls error checking and frame synchronization.

Within the data link layer 120, the LLC sublayer 124 provides flow control and multiplexing for the logical link, while the MAC sublayer 122 provides flow control and multiplexing for the transmission medium. When sending data to another device on the network, the MAC sublayer may encapsulate higher-level frames into frames appropriate for the transmission medium. For example, the MAC sublayer may add a preamble and also padding if necessary, add a frame check sequence to identify transmission errors, and then forward the data to the physical layer as soon as the appropriate channel access method permits it.

In a telecommunication system, the protocol structure may be different from the OSI model. FIG. 1B depicts a layer architecture of a 5G NR protocol structure, which comprises a protocol stack 160 for control plane and a protocol 170 for user plane. The protocol stack for control plane comprises a physical layer 161, a MAC layer 162, a radio link control (RLC) layer 163, a packet data convergence protocol (PDCP) layer 164, a radio resource control (RRC) layer 165, and a non-access stratum (NAS) layer 166. The protocol stack for user plane comprises a physical layer 171, a MAC layer 172, a RLC layer 173, a PDCP layer 174, a service data adaptation protocol (SDAP) layer 175, an internet protocol (IP) layer 176, and an application layer 177. Although the control plane MAC layer and the user plane MAC layer in the 5G NR protocol are not exactly the same as the MAC sublayer in the OSI model, these MAC layers may be configured to have some commonality for improved resource utilization efficiency across different standards or protocols, as described in details in Section B.

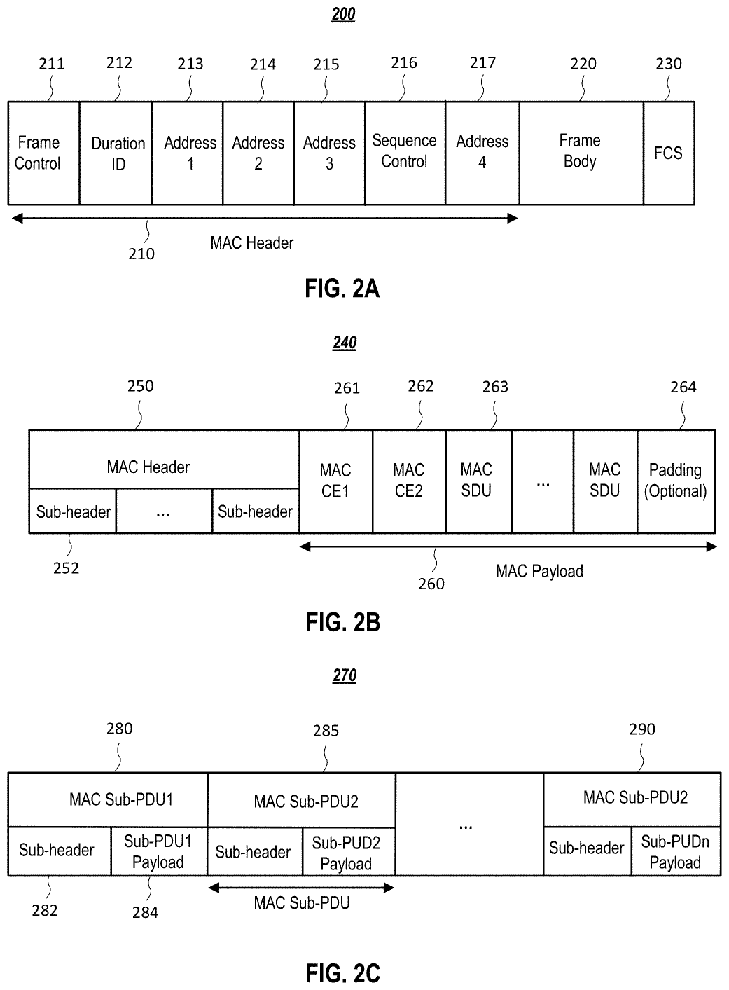

The MAC and LLC layers of IEEE 802 networks, e.g., 802.11 Wi-Fi, operate at the data link layer 120. Among the three types of MAC frames in IEEE 802.11, data frame, control frame, and management frame, only data frames comprises high layer data. FIG. 2A depicts a typical frame structure of a WLAN MAC data frame. The WLAN MAC frame 200 comprises a MAC header 210, a frame body 220, and a frame check sequence (FCS) 230. The MAC header 210 comprises a frame control field 211, duration ID 212, address fields 213-215, a sequence control field 216.

In telecommunications under an LTE protocol, the MAC layer connects the upper layer with the lower layer and transfers data and controlling radio resource. The MAC layer is responsible for mapping between logical channels and transport channels, multiplexing of MAC SDUs from one or different logical channels onto transport blocks (TB) to be delivered to the physical layer on transport channels, etc. An LTE MAC PDU is a bit string of multiple of 8 bits. FIG. 2B depicts a typical frame structure of an LTE MAC protocol data unit (PDU). The LTE MAC PDU 240 comprises a MAC header 250 and a MAC payload 260. The MAC payload 260 comprises MAC control elements (CEs) 261 and 262, one or more MAC service data units (SDUs) 263, and optionally a padding 264. The MAC header 250 comprises one or more sub-header 252 with each sub-header corresponding to either a MAC SDU, a MAC control CE, or padding.

In telecommunications under 5G NR protocol, the MAC layer provides data transfer and radio resource allocation to upper layers. Also, the MAC layer is responsible for mapping between logical and transport channels (downlink and uplink), multiplexing of MAC SDUs onto TBs in uplink (UL) or demultiplexing of MAC SDUs from TBs in downlink (DL), etc. FIG. 2C depicts a typical frame structure of a 5G NR MAC PDU. In an LTE MAC PDU, there is a single header that has all the necessary information for decoding the entire LTE PDU as shown in FIG. 2B. On the contrary, a 5G MAC PDU 270 may comprise one or more MAC sub-PDUs, e.g., 280, 285, and 290, with each MAC sub-PDU starting with a sub-header, e.g., 282, to provide information for the corresponding payload e.g., 284, in the MAC sub-PDU. In 5G, MAC sub-PDUs may be assembled in advance. Once a grant is available, MAC may simply add necessary padding and concatenate the MAC sub-PDUs.

In a 5G NR, a MAC sub-PDU always starts with a sub-header, which is followed by a MAC SDU, a MAC CE or padding (optional). When a set of MAC sub-PDUs doesn't exactly fill a TB, a MAC sub-PDU with padding is included. A MAC sub-PDU with only a sub-header may imply zero-length padding. The order of sub-PDUs in a MAC PDU may be defined. In an uplink, the order of concatenation is MAC SDU(s), CEs, and padding. In a downlink, the concatenation order is MAC CEs, SDU(s) and padding.

One skilled in the art shall understand that although only WLAN, LTE and 5G NR are shown in FIGS. 2A-2C as exemplary wireless standards, a wireless standard may not be limited to the those examples, and be referred as different versions of one type wireless communication, e.g., 5G Wi-Fi, Wi-Fi 4 (wireless-N), Wi-Fi 5 (wireless-AC), Wi-Fi 6 (AX Wi-Fi), etc.

As shown above, different wireless standards have different protocols and requirements for MAC layer frame. It is desired to run multiple wireless standards, e.g., 4G, 5G, or Wi-Fi, on a single hardware together. Typical solutions include developing dedicated hardware accelerators for each wireless standard, for each radio per wireless standard, and even dedicated hardware for each direction (RX/TX). Such solutions may have disadvantages of high area, high power, and complex implementation due to excessive hardware interfaces.

Described hereinafter are system and method embodiments for lower MAC protocol processing across multiple wireless standards and multiple radios to achieve low area and low power MAC hardware.

B. Embodiments for Lower MAC Protocol Processing

A lower MAC layer implementation of a wireless standards involves many components, e.g., an interface to the physical layer, an interface to a higher MAC layer (software, hardware, or a combination of both), a lower MAC layer protocol processing unit to implement functions such as encapsulation/decapsulation of packets (e.g., PSDUs/aggregated mac PDUs in Wi-Fi, TBs in NR/LTE, etc.), frame check sequence (FCS)/cyclic redundancy check (CRC), scrambling/descrambling, and processing of decapsulated packet headers and deriving metadata.

While there are variations in each wireless standard, many of the control and hardware accelerations in the lower MAC layer may have commonality. For example, the interface to the physical layer is in units of codeblock, which may be memory mapped. The interface to the higher MAC is in terms of free buffer lists (for RX), filled buffers (RX/TX), etc. Furthermore, the functionality of a specific wireless standard across different users is common. Infrastructure components for reading/writing of data from/to internal/external memories are common. The processing flow of packets may be implemented to have at least few commonalities across wireless standards. When these resources may be managed to leverage these commonalities, the efficiency in power consumption and hardware resources utilization may be improved.

In this section, embodiments for lower MAC protocol processing across multiple wireless standards and multiple radios. In embodiments, a common hardware is used for processing lower MAC flows across multiple wireless standards (e.g., WLAN, 5G NR, or LTE, etc.), multiple radios within a wireless standard, multiple users within a wireless standard (e.g., Physical Layer Convergence Protocol (PLCP) Service Data Units (PSDUs) in WLAN, TBs in NR/LTE), and/or different directions of radio (RX/TX). The implementation may support partial data processing of a flow, switching across flows, and context saving/restoring of flows. With the implementation of one or more embodiments, support for multiple flows with a common hardware may be achieved. Furthermore, for better performance, looking ahead of flows and prefetching of context and data may also be implemented. Embodiments of the present patent disclosure may result in a very area-efficient and power-efficient hardware implementation for lower MAC protocol processing.

In one or more embodiments, common hardware architecture, with save/restore of needed hardware context in an internal memory which is per wireless standard, per user in a wireless standard and per direction (RX/TX), is used to achieve an area-efficient and power-efficient hardware with common interfaces to the block.

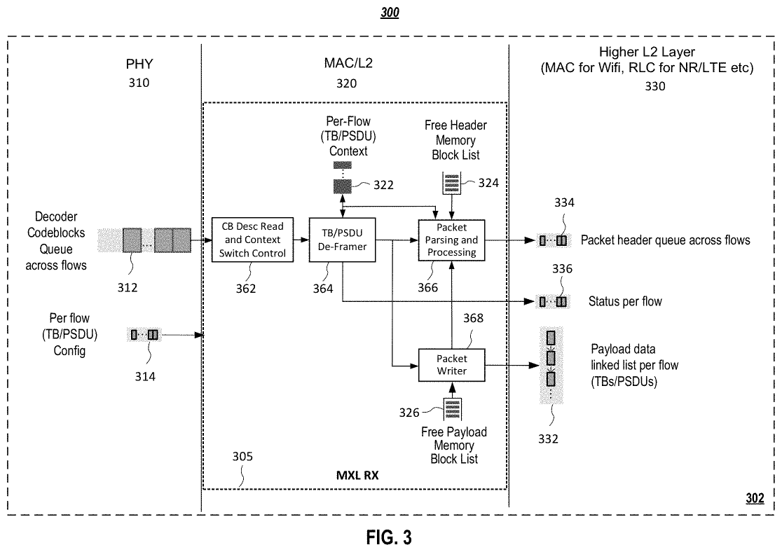

FIG. 3 graphically depicts a schematic of lower MAC protocol processing for receiving data flows (also referred as RX flows) across multiple wireless standards, according to embodiments of the present disclosure. A plurality of decoder codeblocks 312 across multiple RX flows and a plurality of RX configuration blocks 314 are sent from a physical layer (PHY) 310 for RX data processing in hardware 305 at a MAC or L2 layer 320. It shall be understood that depending on specific implementation, the MAC/L2 layer 320 may be a MAC layer (e.g., 162 or 172) or a MAC sublayer (e.g., sublayer 122 in L2 layer 120). Each RX flow may correspond to a wireless standard, a user, or a user per standard (when there are multiple users within the same wireless standard). Each RX flow may comprise one or more codeblocks. Each configuration block comprises configuration information, e.g., flow size, wireless standard, etc., for a corresponding RX flow.

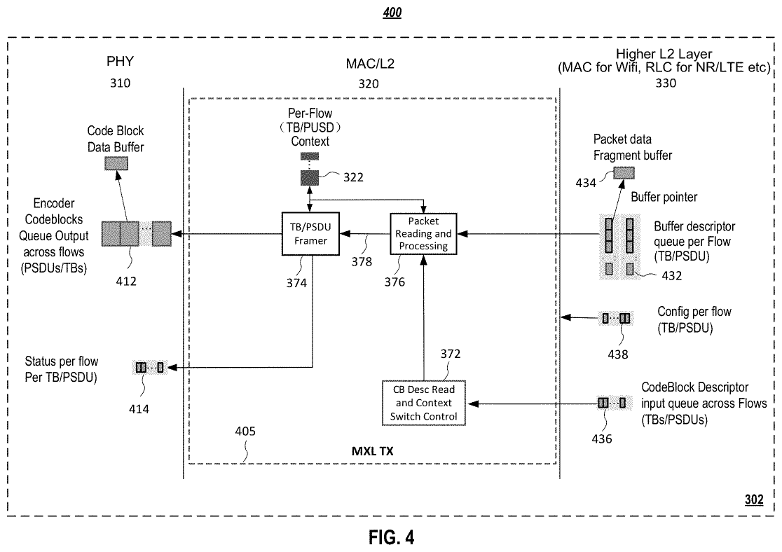

In one or more embodiments, the hardware 305 may comprise one or more blocks or units for data processing in RX/TX directions. The hardware 305 is described in separate diagrams in RX direction in FIG. 3 and in TX direction in FIG. 4. Although the RX/TX diagrams may involve different components or shared components serving different functions in RX/TX flow processing, a single or unified hardware integrating all the components may be adopted for both RX and TX implementations. Components in the hardware 305 for RX flow processing may comprise a context switch control unit 362, a de-framer 364, a packet parsing and processing unit 366, and a packet writer 368. The context switch control unit 362 performs codeblock descriptor reading for the plurality of decoder codeblocks 312 and switching operation across different RX data flows, different users, and/or different wireless standards. The de-framer 364 performs de-framing operation for a data unit, e.g., TB/PSDU, to extract data packets within the data unit. The de-framer 364 may couple to a flow context memory 322 to save RX flow information to the flow context memory 322 or fetch saved RX flow information from the flow context memory 322. The saved RX flow information is information needed to resume RX flow processing from where the processing is stopped and may comprise one or more from a group comprising a header, a sub-header, a padding, a CRC, a scrambler state, payload buffer state, or remaining flow size, etc. The packet parsing and processing unit 366 performs parsing and processing operation for output from the de-framer 364 to generate packet metadata 334, e.g., packet headers. The packet parsing and processing unit 366 also couples to the flow context memory 322 to save associated flow information to the flow context memory 322 or fetch saved associated flow information from the flow context memory 322. In one or more embodiments, the state of the block, when a codeblock is complete for a flow, is stored in the flow context memory and may be retrieved back to the block when the same flow's codeblock arrives again. The packet writer 368 receives the data packets output from the de-framer 364 and generates one or more decapsulated packets 332, e.g., payload data linked list per RX flow.

In the MAC/L2 layer 320, the plurality of decoder codeblocks 312 and the plurality of RX configuration blocks 314 are processed to output one or more decapsulated packets 332, along with packet metadata 334, and an overall status 336 for each of the multiple RX flows. In one or more embodiments, the packet metadata 334 across the multiple RX flows may be transmitted in a packer header queue for further processing in a higher layer 330, which is a layer or a sublayer high than the MAC/L2 layer 320. For example, the higher layer 330 may be a LLC sublayer within a data link layer, higher MAC data plane stage in WLAN implementation, an RLC layer or PDCP layer in NR/LTE implementation, or a network layer. The PHY 310, the MAC/L2 layer 320, and the higher layer 330 are all within a communication device 302, e.g., a wireless phone, a laptop, a router, an access point, a network interface controller (NIC), a base station, etc.

In one or more embodiments, the MAC layer 320 comprises a flow context memory 322, a header memory 324, and a payload memory 326. The flow context memory 322 may be used for storing hardware context or fetching stored hardware context for at least one of the multiple RX flows. The header memory 324 may be used for storing header or sub-header data or fetching stored header or sub-header data for at least one of the multiple RX flows. The payload memory 326 may couple to the packet writer 368 to provide one or more decapsulated packets 332, e.g., payload data linked list per RX flow.

As a short summary for RX flow processing, in the MAC/L2 layer 320, the plurality of decoder codeblocks 312 are processed to output one or more decapsulated packets 332, along with packet metadata 334, and a flow status 336 for each of the multiple RX flows. In one or more embodiments, the packet metadata 334 across the multiple RX flows may be stored in a packer header queue for further processing in a higher layer 330.

FIG. 4 graphically depicts a schematic of lower MAC protocol processing for transmitting data flows (also referred to as TX flows) across multiple wireless standards, according to embodiments of the present disclosure. A plurality of packets 432 across multiple TX flows, a plurality of codeblock descriptors 436, and a plurality of TX configuration blocks 438 are output from a higher layer 330 for TX data processing in hardware 405 at the MAC layer 320. In one or more embodiments, the hardware 405 may or may not be the same hardware as the hardware 305. Each TX flow may correspond to a wireless standard, a user, or a user per standard (when there are multiple users within the same wireless standard). Each TX flow may have one or more data packets. Each configuration block comprises configuration information, e.g., wireless standard, flow size, etc., for a corresponding TX flow. In one or more embodiments, the plurality of packets 432 may be stored in a packet data buffer 434 and be accessible via a buffer pointer.

Components in the hardware 305 for TX flow processing may comprise a context switch control unit 372, a framer 374, and a packet reading and processing unit 376. The context switch control unit 372 performs codeblock descriptor reading for the plurality of codeblock descriptors 436 and switching operation across different TX data flows. The packet parsing and processing unit 376 performs parsing and processing operations for the data packets, fetched from the packet data fragment buffer 434, to generate one or more processed data packets 378. The framer 374 performs framing operation for the one or more processed data packets 378 to form one or more encoder codeblocks 412 across multiple TX flows. The framer 374 is coupled to a flow context memory 322 to save TX flow information to the flow context memory 322 or fetch saved TX flow information from the flow context memory 322. The saved TX flow information may be information needed to resume TX flow processing from where the processing is stored and may comprise one or more from a group comprising a header, a sub-header, a padding, a CRC, a scrambler state, payload buffer state, or remaining flow size, etc.

In one or more embodiments, one or more components in the hardware 305 may be configured for both TX flow processing and RX flow processing. For example, the framer 374 and the de-framer 364 may be the same hardware and be configured for de-framing operation when handling RX flows and for framing operation when handling TX flows.

As a short summary for TX flow processing, in the MAC layer 320, the plurality of packets 432, the plurality of codeblock descriptors 436, and the plurality of TX configuration blocks 438 are processed to generate one or more encoder codeblocks 412 for each of the multiple TX flows, along with a flow status 414 for each TX flow towards the PHY 310.

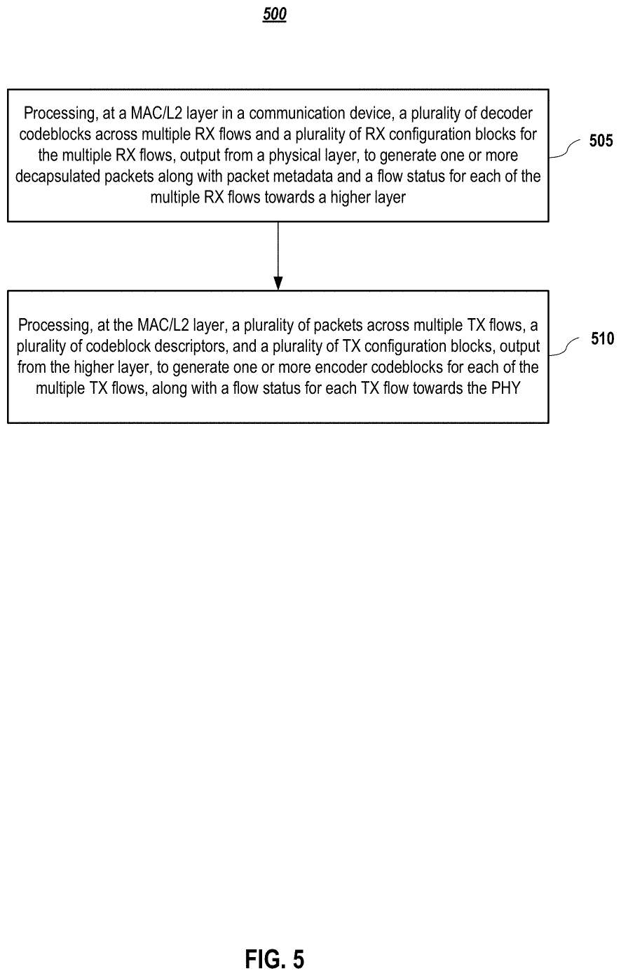

FIG. 5 depicts a process of lower MAC protocol processing across multiple wireless standards, according to embodiments of the present disclosure. In step 505, a MAC layer in a communication device processes a plurality of decoder codeblocks across multiple RX flows and a plurality of configuration blocks for the multiple RX flows output from a physical layer to generate one or more decapsulated packets along with packet metadata and a flow status for each of the multiple RX flows towards a higher layer. In step 510, the MAC layer processes a plurality of packets across multiple TX flows, a plurality of codeblock descriptors, and a plurality of configuration blocks, output from the higher layer, to generate one or more encoder codeblocks for each of the multiple TX flows, along with a flow status for each TX flow towards the PHY. One skilled in the art shall understand the step 505 and 510 may also be implemented in parallel, alternatively, or in an opposite order from FIG. 5. Such variations shall still be within the scope of the present disclosure.

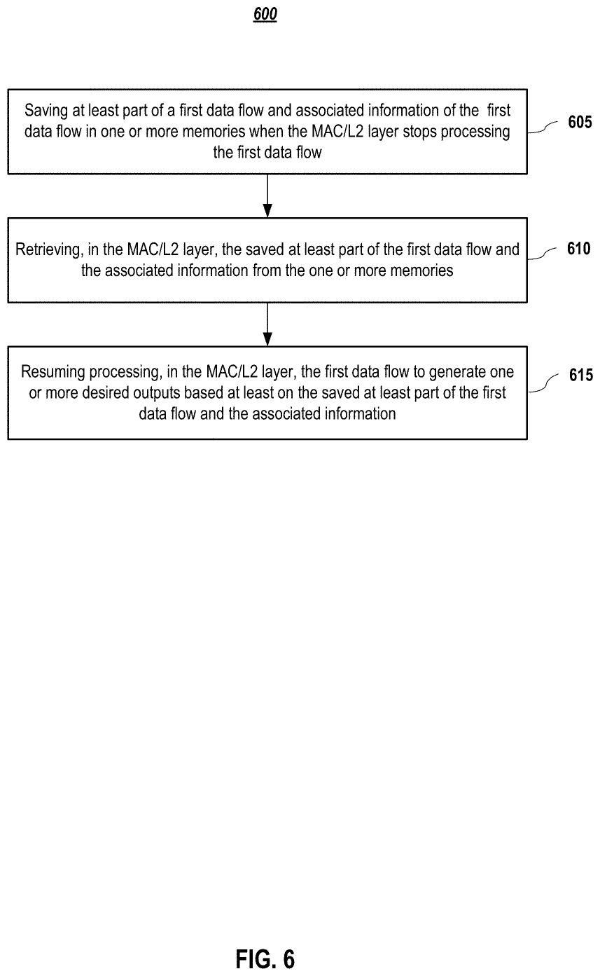

In one or more embodiments, for RX or TX direction, each flow may be active at a time for a codeblock unit. In a codeblock sequence, the MAC/L2 layer may temporarily suspend or stop processing a first data flow and switch to process a second data flow based on one or more constraints. FIG. 6 depicts a process of switching data flow processing, according to embodiments of the present disclosure. In step 605, when the MAC/L2 layer stops processing the first data flow, at least part of the first data flow and associated information are saved in one or more memories (e.g., the flow context memory 322, the header memory 324, and/or the payload memory 326) within the MAC/L2 layer. The associated information is information needed to resume processing the first RX or TX flow from where the processing is stored and may comprise one or more from a group comprising a header, a sub-header, a padding, a CRC, a scrambler state, payload buffer state, or remaining flow size, etc. The constraints that cause switching flow processing may comprise a time interval required to process a data flow for a wireless standard, a payload size for a flow, data rate of the data flow, signal-to-noise ratios (SNRs) for different wireless channels, etc. For example, a weak Wi-Fi connection may cause a longer latency for data transmission. To avoid a potential signal transmission failure, it might be desirable to process a Wi-Fi flow in the MAC/L2 layer before processing a big LTE flow to minimize the Wi-Fi latency. When the first data flow is suspended or stopped from processing, the payload of the first data flow may be stored in the payload memory 326 (when the first data flow is an RX flow) or data fetching of the first data flow from the packet data buffers 434 is suspended or stopped (when the first data flow is a TX flow). The processed part of a header or a sub-header of the first flow may be stored in the header memory 324 such that the MAC/L2 layer may resume processing the first data flow from where it stops to minimize processing delays. The header or sub-header associated with the first data flow may be a WLAN MAC header (e.g., MAC header 210) when the first data flow is a Wi-Fi flow, an LTE MAC header or sub-header (e.g., MAC header 250 or sub-header 252) when the first data flow is a LTE flow, or a sub-header (e.g., sub-header 282) of a 5G MAC sub-PDU when the first data flow is a 5G flow.

In step 610, when the MAC/L2 layer resumes processing the first data flow, the MAC layer retrieves the saved at least part of the first data flow and the associated information from the one or more memories (when the first data flow is a RX flow), or data fetching of the first data flow from the packet data buffers 434 resumes (when the first data flow is a TX flow) from where the data fetching stopped. In step 615, the MAC layer resumes processing the first data flow to generate one or more desired outputs based at least on the saved at least part of the first data flow and associated information. In one example, the first data flow may be a Wi-Fi data flow comprising one or more data packets. The MAC/L2 layer may be running a CRC for the first data flow and finishes checking for only part of the one or more data packets when the MAC/L2 layer stops processing the first data flow. The MAC/L2 layer may save an end point of the CRC to a memory (e.g., the flow context memory 322). When the MAC/L2 layer resumes processing the first data flow, the MAC/L2 layer fetches the end point and restarts the CRC from the end point instead of running CRC for the entire data flow again.

In certain situations, the MAC/L2 layer may look ahead beyond a currently processing data flow and actively pre-fetch at least part (e.g., payload, header, or sub-header, etc.) of one or more flows subsequent to the current processing data flow, which may further improve the efficiency for the MAC layer to process multiple data flows.

It shall be noted that a higher layer may be a layer or sublayer for RLC, PDCP or Network Layer for NR/LTE, and for WLAN, the higher layer may be one or more stages in a MAC data plane, an LLC layer, or a Network Layer. The aforementioned embodiments for shared hardware across multiple wireless technologies or users may be applied for various applications. For example, crypto implementation may be a common one where the same crypto hardware may be shared since Advanced Encryption Standard (AES) may be common across various wireless standards. Service Data Unit (SDU) processing hardware for packets interfacing with a Network Layer may also be shared across multiple wireless standards. Such variations or extensions are also within the true spirit and scope of the present disclosure.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by one or more processing devices. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently, including having multiple dependencies, configurations, and combinations.

What is claimed is:

1. A method for data flow processing comprising:
processing, at a medium access control (MAC) layer or a MAC sublayer within a communication device, a plurality of decoder codeblocks across multiple receiving data (RX) flows and a plurality of RX configuration blocks for the multiple RX flows to generate one or more decapsulated packets along with packet metadata and a flow status for each of the multiple RX flows towards a higher layer, the plurality of decoder codeblocks and the plurality of configuration blocks are output from a physical layer (PHY); and
processing, at the MAC layer or the MAC sublayer, a plurality of packets across multiple transmission data (TX) flows, a plurality of codeblock descriptors, and a plurality of TX configuration blocks, output from the higher layer, to generate one or more encoder codeblocks for each of the multiple TX flows, along with a flow status for each TX flow towards the higher layer.

2. The method of claim 1 wherein each of the multiple RX or TX flows comprises one or more codeblocks corresponding to a wireless standard, a user, or a user per wireless standard.

3. The method of claim 2 wherein the wireless standard has a Wi-Fi protocol, a long-term evolution (LTE) protocol, or a 5G new radio (NR) protocol.

4. The method of claim 1 wherein the higher layer is:
a layer or sublayer for radio link control (RLC), packet data convergence protocol (PDCP), a network layer for new radio (NR); or
a stage in MAC data plane, a logical link control (LLC) layer, or Network Layer for wireless local area network (WLAN).

5. The method of claim 1 further comprising:
storing, in a flow context memory within the MAC layer or the MAC sublayer, hardware context or fetching, from the flow context memory, stored hardware context for at least one of the multiple RX flows;
storing, in a header memory within the MAC layer or the MAC sublayer, header or sub-header data or fetching, from the header memory, stored header or sub-header data for at least one of the multiple RX flows; and
storing, in a payload memory within the MAC layer or the or the MAC sublayer, payload data for at least one of the multiple RX flows.

6. The method of claim 5 wherein the header or sub-header data is from a group comprising at least a wireless local area network (WLAN) MAC header, a long-term evolution (LTE) MAC header or sub-header, and a sub-header for a 5G MAC sub-protocol data unit (sub-PDU).

7. The method of claim 1 further comprising:
saving at least part of a first RX or TX flow and associated information of the first RX or TX flow in one or more memories within the MAC layer or the MAC sublayer when the MAC layer or the MAC sublayer stops processing the first RX or TX flow;
retrieving, in the MAC layer or the MAC sublayer, the saved at least part of the first RX or TX flow and the associated information from the one or more memories;
resuming processing, in the MAC layer, the first RX or TX flow to generate one or more desired outputs based at least on the saved first RX or TX flow and the associated information.

8. The method of claim 7 wherein the associated information is information needed to resume processing the first RX or TX flow from where the processing is stored.

9. The method of claim 1 further comprising:
pre-fetching, at the MAC layer or the MAC sublayer, at least part of one or more RX or TX flows subsequent to a RX or TX flow that is currently processed in the MAC layer or the MAC sublayer.

10. A communication device comprising:
a physical layer (PHY);
a medium access control (MAC) layer or MAC sublayer coupled to the PHY, the MAC layer or MAC sublayer is configured for:
processing a plurality of decoder codeblocks across multiple receiving data (RX) flows and a plurality of RX configuration blocks for the multiple RX flows to generate one or more decapsulated packets along with packet metadata and a flow status for each of the multiple RX flows, the plurality of decoder codeblocks and the plurality of configuration blocks are output from PHY; and
processing a plurality of packets across multiple transmission data (TX) flows, a plurality of codeblock descriptors, and a plurality of TX configuration blocks to generate one or more encoder codeblocks for each of the multiple TX flows, along with a flow status for each TX flow towards the PHY; and
a higher layer coupled to the MAC layer or the MAC sublayer, the higher layer outputs to the MAC layer or MAC sublayer the plurality of packets across multiple TX flows, the plurality of codeblock descriptors, and the plurality of TX configuration blocks, and receives from the MAC layer or the MAC sublayer the one or more decapsulated packets, the packet metadata and the flow status for each of the multiple RX flows.

11. The communication device of claim 10 wherein each of the multiple RX or TX flows comprises one or more codeblocks corresponding to a wireless standard, a user, or a user per wireless standard.

12. The communication device of claim 11 wherein the wireless standard has a Wi-Fi protocol, a long-term evolution (LTE) protocol, or a 5G new radio (NR) protocol.

13. The communication device of claim 10 wherein the higher layer is:
a layer or sublayer for radio link control (RLC), packet data convergence protocol (PDCP), a network layer for new radio (NR); or
a stage in MAC data plane, a logical link control (LLC) layer, or Network Layer for wireless local area network (WLAN).

14. The communication device of claim 10 wherein the MAC layer or the MAC sublayer further comprising:
a flow context memory for storing hardware context or fetching stored hardware context for at least one of the multiple RX flows;
a header memory for storing header or sub-header data or fetching stored header or sub-header data for at least one of the multiple RX flows; and
a payload memory for storing payload data or fetching stored payload data for at least one of the multiple RX flows.

15. The communication device of claim 10 wherein the MAC layer or the MAC sublayer is further configured for:
Saving at least part of a first RX or TX flow and associated information of the first RX or TX flow in one or more memories within the MAC layer when the MAC layer or the MAC sublayer stops processing the first RX or TX flow;
retrieving, in the MAC layer or the AMC sublayer, the saved at least part of the first RX or TX flow and the associated information from the one or more memories;
resuming processing, in the MAC layer or the MAC sublayer, the first RX or TX flow to generate one or more desired outputs based at least on the saved at least part of the first RX or TX flow and the associated information.

16. A non-transitory computer-readable medium or media comprising one or more sequences of instructions which, when executed by at least one processor, causes steps for data packet processing comprising:
processing, at a medium access control (MAC) layer or a MAC sublayer within a communication device, a plurality of decoder codeblocks across multiple receiving data (RX) flows and a plurality of RX configuration blocks for the multiple RX flows to generate one or more decapsulated packets along with packet metadata and a flow status for each of the multiple RX flows towards a higher layer, the plurality of decoder codeblocks and the plurality of configuration blocks are output from a physical layer (PHY); and
processing, at the MAC layer or the MAC sublayer, a plurality of packets across multiple transmission data (TX) flows, a plurality of codeblock descriptors, and a plurality of TX configuration blocks, output from the higher layer, to generate one or more encoder codeblocks for each of the multiple TX flows, along with a flow status for each TX flow towards the PHY.

17. The non-transitory computer-readable medium or media of claim 16 wherein each of the multiple RX or TX flows comprises one or more codeblocks corresponding to a wireless standard, a user, or a user per wireless standard.

18. The non-transitory computer-readable medium or media of claim 15 further comprising one or more sequences of instructions which, when executed by at least one processor, causes steps to be performed comprising:
storing, in a flow context memory within the MAC layer or the MAC sublayer, hardware context or fetching, from the flow context memory, stored hardware context for at least one of the multiple RX flows;
storing, in a header memory within the MAC layer or the MAC sublayer, header or sub-header data or fetching, from the header memory, stored header or sub-header data for at least one of the multiple RX flows; and
storing, in a payload memory within the MAC layer or the MAC sublayer, payload data for at least one of the multiple RX flows.

19. The non-transitory computer-readable medium or media of claim 15 further comprising one or more sequences of instructions which, when executed by at least one processor, causes steps to be performed comprising:
saving at least part of a first RX or TX flow and associated information of the first RX or TX flow in one or more memories within the MAC layer when the MAC layer or the MAC sublayer stops processing the first RX or TX flow;
retrieving, in the MAC layer or the MAC sublayer, the saved at least part of the first RX or TX flow and the associated information from the one or more memories; and
resuming processing, in the MAC layer or the MAC sublayer, the first RX or TX flow to generate one or more desired outputs based at least on the saved at least part of first RX or TX flow and the associated information.

20. The non-transitory computer-readable medium or media of claim 19 wherein the associated information is information needed to resume processing the first RX or TX flow from where the processing is stored.
